(19) United States
(12) Patent Application Publication
(10) Pub. No.: US 2003/0222915 A1
(43) Pub. Date: Dec. 4, 2003

(54) Data processor controlled display system with drag and drop movement of displayed items from source to destination screen positions and interactive modification of dragged items during the movement

(75) Inventors: Neal Richard Marion, Georgetown, TX (US); George F. Ramsay III, Cedar Park, TX (US)

Correspondence Address: International Business Machines Corporation, Intellectual Property Law Department, Internal Zip 4054, 11400 Burnet Road, Austin, TX, 78758, US

(73) Assignee: International Business Machines Corporation, Armonk, NY

(21) Appl. No.: 10/159,509

(22) Filed: May 30, 2002

(51) Int. Cl. G09G 5/00

(52) U.S. Cl. 345/769; 345/837

(57) ABSTRACT

In a basic display screen interface implementation for enabling an interactive user to move a data component from a source to a destination in said system via means for representing said data component by an item, e.g. icon on said display screen combined with means for interactively dragging said item from an initial location on said screen representative of said source to a final location representative of said destination, there is provided a further expedient for interactively modifying the data component before said dragged item reaches said final location. The implement for dragging said icon includes an implement for dragging the icon into contact with another icon to thereby activate the means for interactively modifying the data component represented by said dragged icon.

### TECHNICAL FIELD

The present invention relates to user interactive computer supported display technology and particularly to Graphical User Interfaces (GUIS) that are user-friendly and provide interactive users with an interface environment that is easy to use.

### BACKGROUND OF RELATED ART

The past decade has been marked by a technological revolution driven by the convergence of the data processing industry with the consumer electronics industry. This advance has been even further accelerated by the extensive consumer and business involvement in the Internet or World Wide Web (Web) over the past several years. As a result of these changes, it seems as if virtually all aspects of human endeavor in the industrialized world require human-computer interfaces. These changes have made computer directed activities accessible to a substantial portion of the industrial world's population, which, up to a few years ago, was computer-illiterate, or, at best, computer indifferent.

In order for the vast computer supported industries and market places to continue to thrive, it will be necessary for increasing numbers of workers and consumers who are limited in computer skills to become involved with computer interfaces. Despite all of the great changes that have been made in the computer industry, the screen cursor controlled manually by the user still remains the primary human-computer interface. The user still commands the computer primarily through manual pointing devices such as mice, joy sticks and trackballs that control the on-screen cursor movements.

Icons in GUIs are, of course, the primary access through which the user may interactively select substantially all computer functions and data. Thus, the number of icons that the user has to contend with in the navigation of his cursor to his target icon has been greatly increasing. These may be arranged in many layers of windows.

One function that developers of display interfaces have been addressing is ease of use in moving data between the various operations represented on the display screen. One result has been the “drag and drop” implementations wherein the interactive user points to an element or object on the screen and then guides it from its source location to a destination or target location on the screen, usually using the cursor to point and guide the element, which is often an icon representative of some form of a data component stored in the computer. As a result of the drag and drop operation, the data represented by the icon is transferred from an operation represented at its source location to one represented at its destination location. Drag and drop operations have been used to transfer displayed objects or items within a screen window, as well as between different windows in the same desktop session currently activated on a display screen. Drag and drop remains a very simple user-friendly expedient for moving data.

### SUMMARY OF THE PRESENT INVENTION

The present invention offers a new implementation for interactively moving and manipulating data components represented by displayed items, e.g. icons in a simple user-friendly manner that takes advantage of drag and drop processes.

The present invention is implemented in a computer controlled user interactive display environment. It provides a basic display screen interface implementation for enabling an interactive user to move a data component from a source to a destination in said system via means for representing said data component by an item, e.g. icon on said display screen combined with means for interactively dragging said item from an initial location on said screen representative of said source to a final location representative of said destination. In such an environment the invention then provides further means for interactively modifying said data component before said dragged item reaches said final location.

According to an aspect of the invention, the means for dragging the icon includes means for dragging the icon into contact with another icon to thereby activate the means for interactively modifying the data component represented by said dragged icon. Also during the movement of the dragged icon, the another icon may itself be moved into the path of the dragged icon to thereby initiate the modification.

The modification may be of the data content of the data component represented by the dragged icon. Also, the another icon may represent another data component and the data component of the dragged icon may thus be modified by combining data content of the another data component with the data content of the data component of the dragged icon.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a diagrammatic view of a display screen illustrating a GUI display screen with a hierarchy of windows containing icons;

FIG. 2 is the display screen view of FIG. 1 after an icon has been selected and partially dragged from its source position along its path by the cursor or pointer;

FIG. 3 is the display screen view of FIG. 2 after the dragged icon has been moved further along its path back to its destination while crossing and contacting other icons along its charted path of movement;

FIG. 4 is a display screen view like that of FIG. 3 but showing the movement of the dragged icon along a different charted path that crosses window boundaries in accordance with another aspect of the invention;

FIG. 5 is a block diagram of an interactive data processor controlled display system including a central processing unit that is capable of implementing the drag and drop manipulations of the present invention;

FIG. 6 is a flowchart of the program steps involved in setting up a process of the present invention for changing the data content of a dragged icon during the dragging process;

FIG. 7 is a flowchart of the steps involved in an illustrative run of the process set up in FIG. 6;

FIG. 8 is a diagrammatic view of a portion of a display screen like that of FIG. 1 to illustrate a variation of this invention in the movement of the display screen icons;

FIG. 9 is the display screen view of FIG. 8 after an icon has been selected and partially dragged from its source position along its path by the pointer; and

FIG. 10 is the display screen view of FIG. 9 after the dragged icon has been moved further along its path back to a destination while crossing and contacting other icons along its charted path of movement.

### DETAILED DESCRIPTION OF THE PREFERRED EMBODIMENT

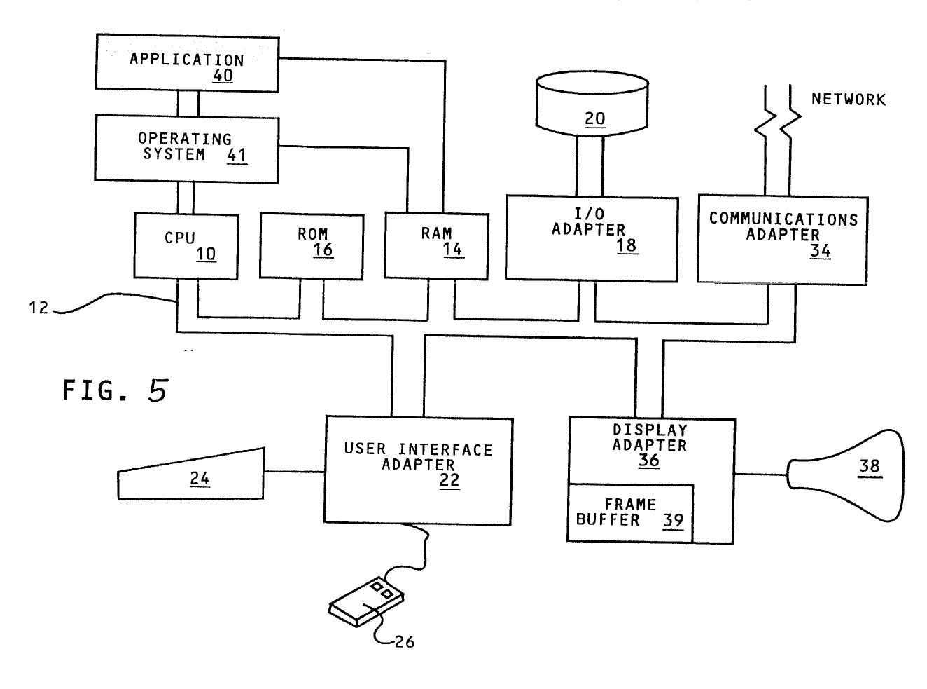

Referring to FIG. 5, a typical data processing system is shown that may function as the computer controlled display terminal used in implementing the system of the present: invention to enable the interactive user to modify the data component of a dragged item or during a drag and drop operation before the dragged icon reaches its destination. A central processing unit (CPU) 10, such as any PC microprocessor in a PC available from International Business Machines Corporation (IBM) or Dell Corp., is provided and interconnected to various other components by system bus 12. An operating system 41 runs on CPU 10, provides control and is used to coordinate the function of the various components of FIG. 5. Operating system 41 may be one of the commercially available operating systems such as Microsoft's Windows98™ or WindowsNT™, as well as UNIX or IBM's AIX operating systems. An application program for permitting the user to drag and drop an icon and modify the contents represented by the icon during dragging, subsequently described in detail, runs in conjunction with operating system 41 and provides output calls to the operating system 41, which in turn implements the various functions to be performed by the application 40. A Read Only Memory (ROM) 16 is connected to CPU 10 via bus 12 and includes the Basic Input/Output System (BIOS) that controls the basic computer functions. Random Access Memory (RAM) 14, I/O adapter 18 and communications adapter 34 are also interconnected to system bus 12. It should be noted that software components, including operating system 41 and application 40, are loaded into RAM 14, which is the computer system's main memory. I/O adapter 18 communicates with the disk storage device 20, i.e. a hard drive. Communications adapter 34 interconnects bus 12 with an outside network enabling the data processing system to communicate with other such systems over a Local Area Network (LAN) or Wide Area Network (WAN), which includes, of course, the Internet. I/O devices are also connected to system bus 12 via user interface adapter 22 and display adapter 36. Keyboard 24 and mouse 26 are all interconnected to bus 12 through user interface adapter 22. Mouse 26 operates in a conventional manner insofar as user movement is concerned. Display adapter 36 includes a frame buffer 39, which is a storage device that holds a representation of each pixel on the display screen 38. Images may be stored in frame buffer 39 for display on monitor 38 through various components such as a digital to analog converter (not shown) and the like. In order to accommodate hierarchies of overlapping windows of the subsequent embodiments, the frame buffer 39 should be a depth buffer, for example the depth buffer of U.S. Pat. No. 5,241,565.

By using the aforementioned mouse or related devices, a user is capable of inputting information to the system through the keyboard 24 or mouse 26 and receiving output information from the system via display 38.

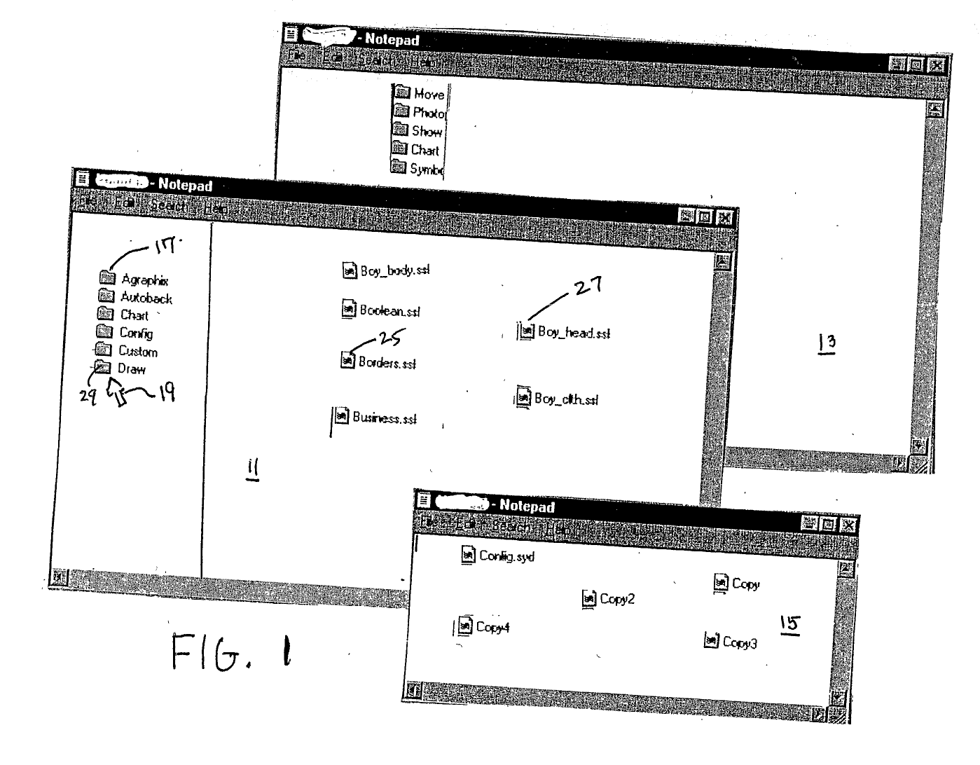

There will now be described a simple illustration of the present invention with respect to the display screens of FIGS. 1 through 4. When the screen images are described, it will be understood that these may be rendered by storing image and text creation programs, such as those in any conventional window operating system in the RAM 14 of the system of FIG. 5. The operating system is diagrammatically shown in FIG. 5 as operating system 41. The display screens of FIGS. 1 through 4 are presented to the viewer on display monitor 38 of FIG. 5. In accordance with conventional techniques, the user may control the screen interactively through a conventional I/O device, such as mouse 26 of FIG. 5, which operates through user interface 22 to call upon programs in RAM 14 cooperating with the operating system 41 to create the images in frame buffer 39 of display adapter 36 to control the display on monitor 38.

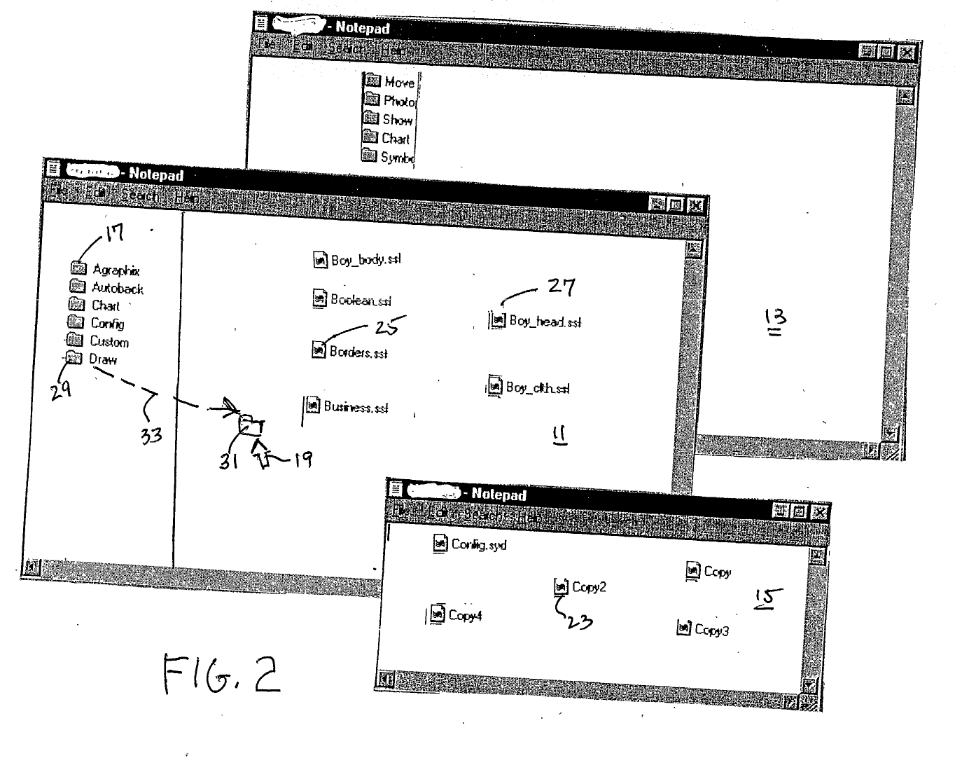

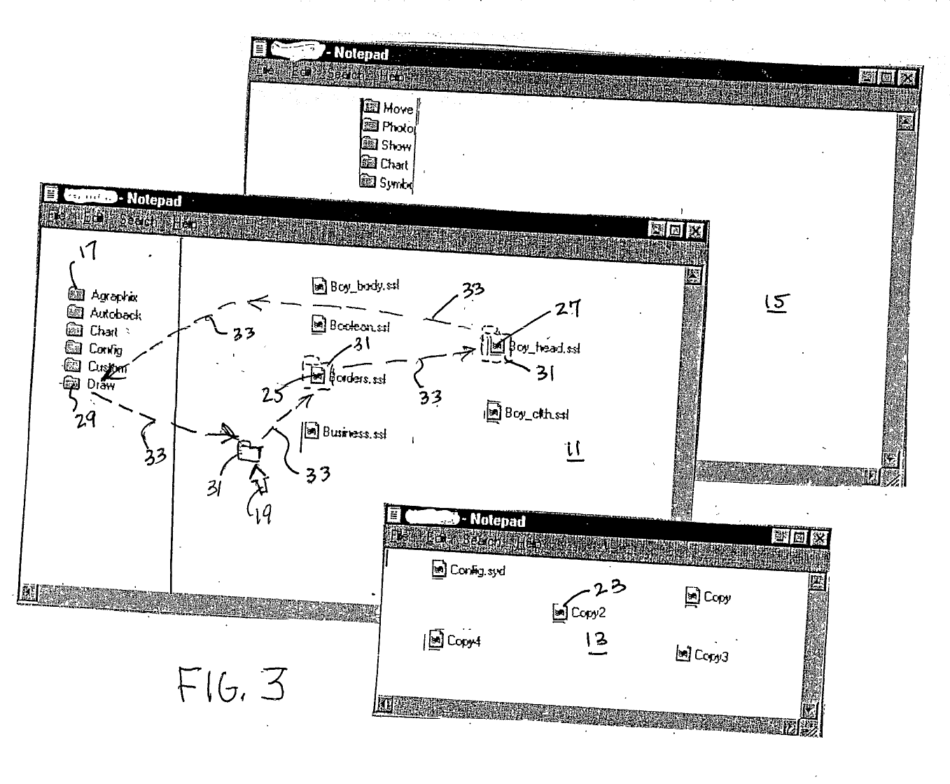

With reference to FIG. 1, a hierarchy, or stack, of overlapping windows 11, 13 and 15 occupies the screen. Let us assume that icon 29, representing a folder in a set of folders 17, is to be dragged from the source position shown and then dropped at a destination position to be subsequently described with respect to FIG. 3. The user moves mouse pointer 19 to the source position of folder icon 29 and, by appropriate mouse pointer clicking, takes hold of folder icon 29. The icon folder now marked as folder 31 is then dragged along path 33 shown in FIG. 2. Then, with respect to FIG. 3, the subsequent path of the dragged icon folder 29 and its various stops are shown in FIG. 3 as dashed lines. Along its path 33, the icon folder 31 is dragged by the pointer so that it traverses icon files 25 and then 27. At each of these stops, as indicated by the outline of folder 31 in dashed lines, the contents of the dragged icon 31 folder is modified to include the contents of the files represented by icons 25 and 27 through appropriate mouse pointer clicking as dragged folder 31 traverses icons 25 and 27. During this traversal by icon folder 31, the contents of the files represented by icons 25 and 27 are temporarily stored or cached. When the dragged icon folder 29 reaches its destination, which in the present case is a return to the initial or source position of icon folder 29, the contents represented by icon folder 29 have been significantly modified to include the contents of cached files represented by icons 27 and 31.

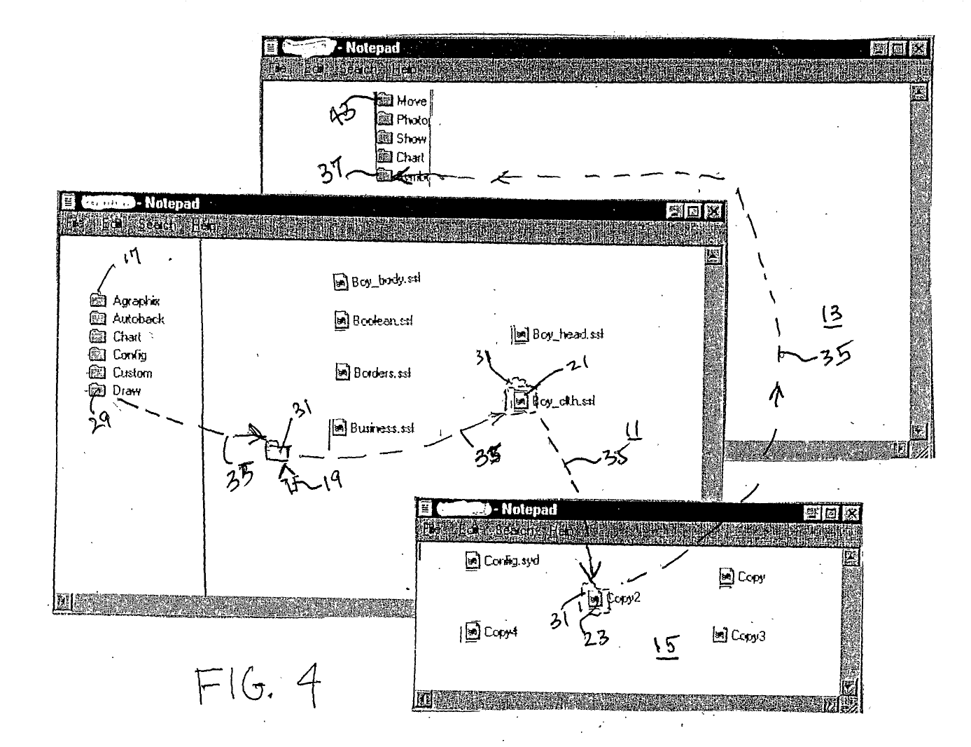

Alternatively, the destination may be another icon, such as another icon folder, and the contents of the dragged folder including the contents of the files traversed and thus cached may be merged into the folder represented by the icon at the destination. This is illustrated with respect to FIG. 4.

With reference to FIG. 4, icon folder 29 is dragged as folder 31 by pointer 19 along path 35 which crosses boundaries in and out of windows 11, 15 and 13 while caching the contents of files 21 and 23, and finally depositing the initial contents of folder 29 as modified to include the cached contents of traversed files 21 and 23 in destination folder 37 of folder set 43 in window 13. For further details on the dragging and dropping of icons across multiple window boundaries, reference is made to copending application Ser. No.: 09/071,369, filed May 4, 1998, H. Amro et al., entitled: A Data Processor Controlled Display System With Drag and Drop Transfer of Objects From an Active Window to a Dynamically Selected Hidden Destination Window, assigned to the assignee of the present invention and is hereby incorporated by reference.

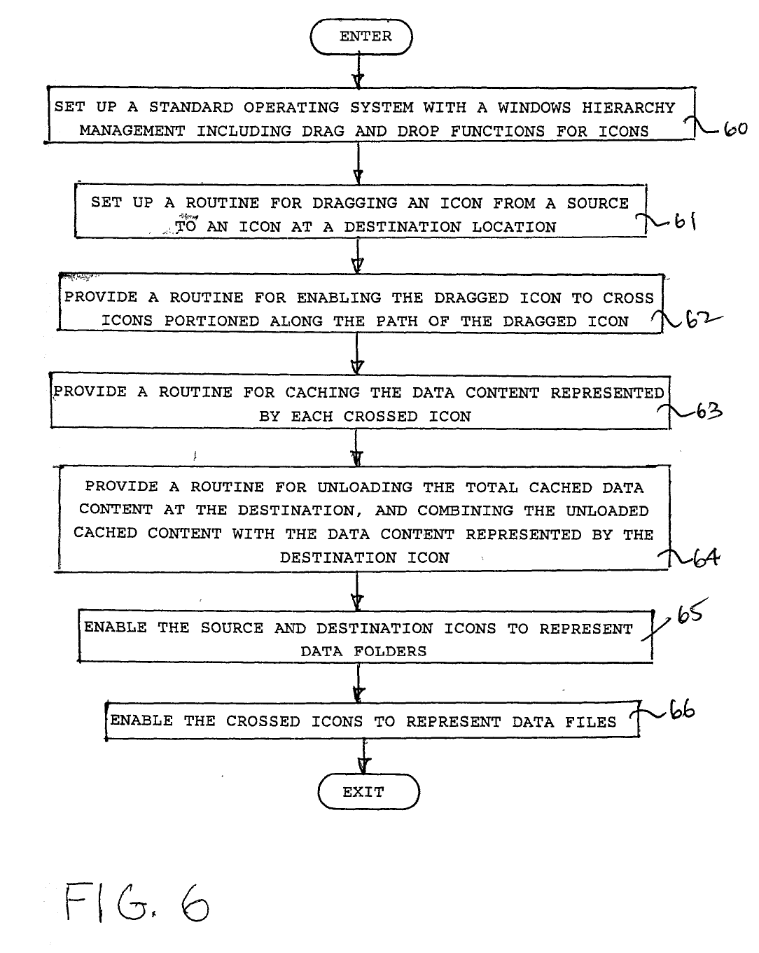

Now, with reference to FIG. 6 there will be described a process implemented by a program according to the present invention for dynamically dragging an item, such as an icon, from a source to a destination on a display while interactively modifying the data content represented by the dragged icon. The program routines that are created by the process of FIG. 6 implement the operations described with respect to FIGS. 1 through 4. In the flowchart of FIG. 6, a basic display GUI interface is set up, step 60, using any operating system for managing a hierarchy of windows, e.g. Windows98™, WindowsNT™ and Motif for Unix or AIX; all have drag and drop functions. Within these windowing protocols, a routine is provided for dragging an icon from a source to an icon at a destination location, step 61. A routine is provided for enabling the dragged icon to cross icons positioned along the path of the dragged icon, step 62, and a routine is provided for caching the data content represented by each crossed icon, step 63. A routine is provided for unloading the total cached data content at the destination and, optionally, for combining the unloaded cached content with the data content of the destination icon, as well as the data content represented by the dragged icon, step 64. In an illustrative example, the source and destination icon may represent data folders, step 65, while the crossed icons may represent data files, step 66.

In a variation of the present invention, the source and destination icons, as well as the crossed icons, may represent objects in an object oriented system wherein the objects represented by the icons may have frameworks and object interfaces that make such objects compatible so as to be combinable into combination objects.

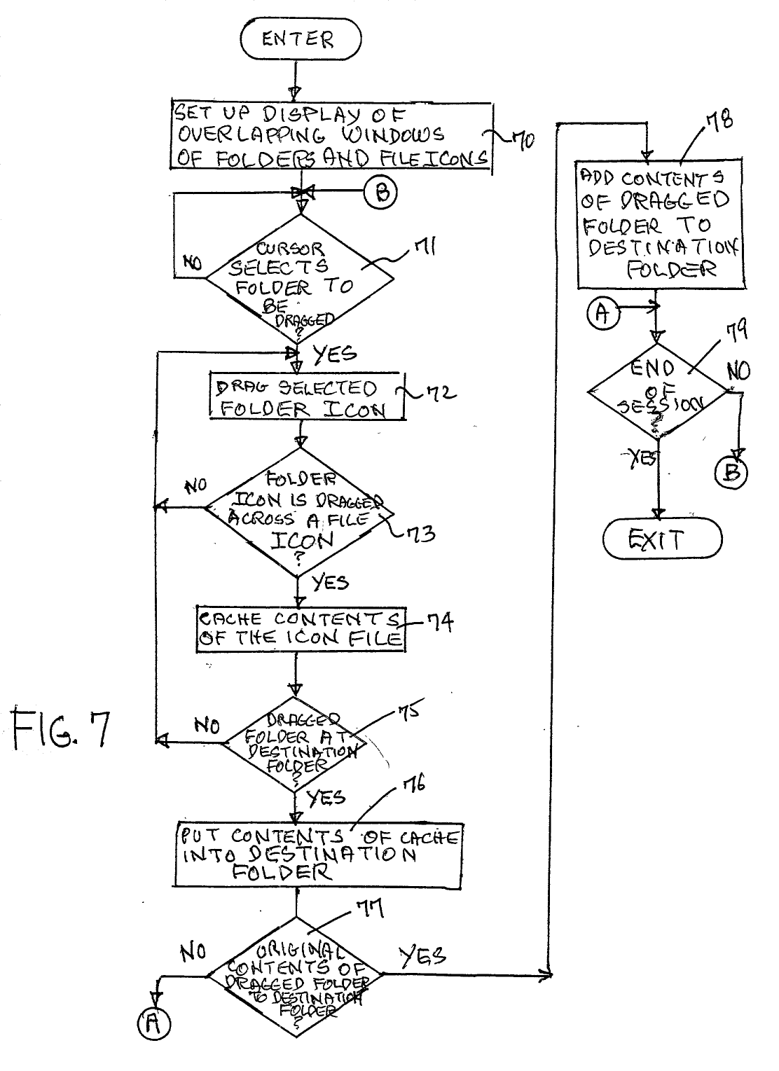

Now that the basic programs have been described and illustrated, there will be described with respect to FIG. 7 a flow of a simple operation showing how the program could be run for a drag and drop implementation wherein a dragged icon content is modified while the icon is being dragged from a source to a destination on a display. First, step 70, a window display screen is set up to have overlapping windows of file and folder icons. Then, step 71, a determination is made as to whether the interactive user with his mouse pointer has selected or pointed to a folder icon to be dragged from a source location to a destination location. If No, the routine is returned to step 71 where such a selection is awaited. If yes, then step 72, the selected folder icon is dragged along the desired path toward a destination. Then, step 73, a determination is made as to whether the folder icon is dragged across a file icon. If No, the routine is returned to step 72 where such a crossing is awaited. If Yes, then, step 74, the data content represented by the crossed file icon is cached. Next a determination is made as to whether the folder icon being dragged has reached the destination folder icon, step 75. If No, the routine is returned to step 72 where another icon crossing is awaited. If Yes, then, step 76, in the present case, the entire contents of the cache is put into the destination folder. At this point, a further determination is made as to whether the original data content represented by the dragged folder icon is also to be put into the destination folder, step 77. If Yes, the contents represented by the dragged icon are added to the contents of the destination folder, step 78. Next, or if the determination in step 77 is No (via branch “A”), a further determination may conveniently be made as to whether the session is at an end, step 79. If Yes, the session is exited. If No, the process is branched back, via “B”, to step 71 where the initial determination is made as to whether another icon has been selected for branching.

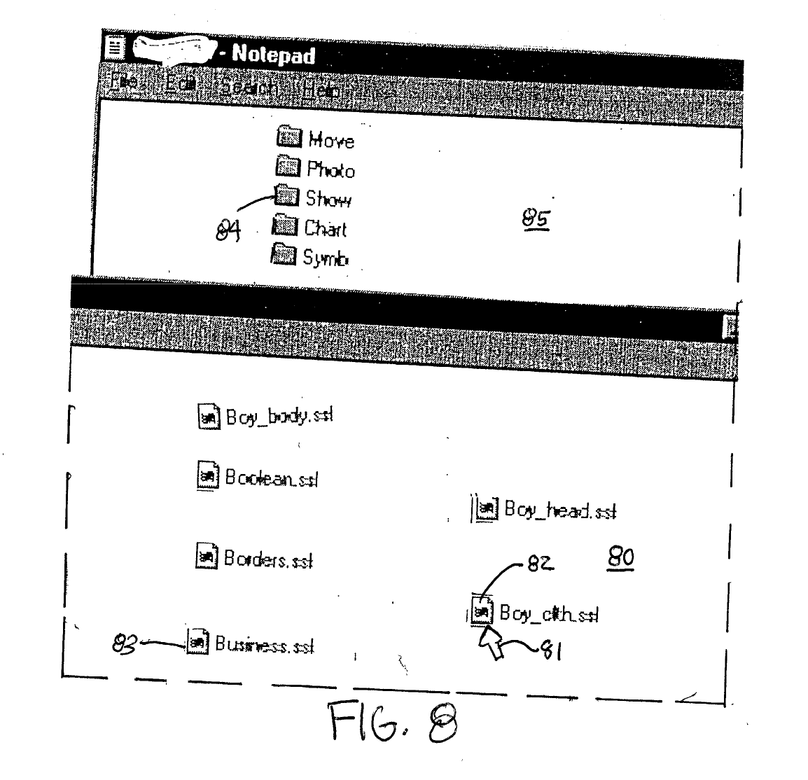

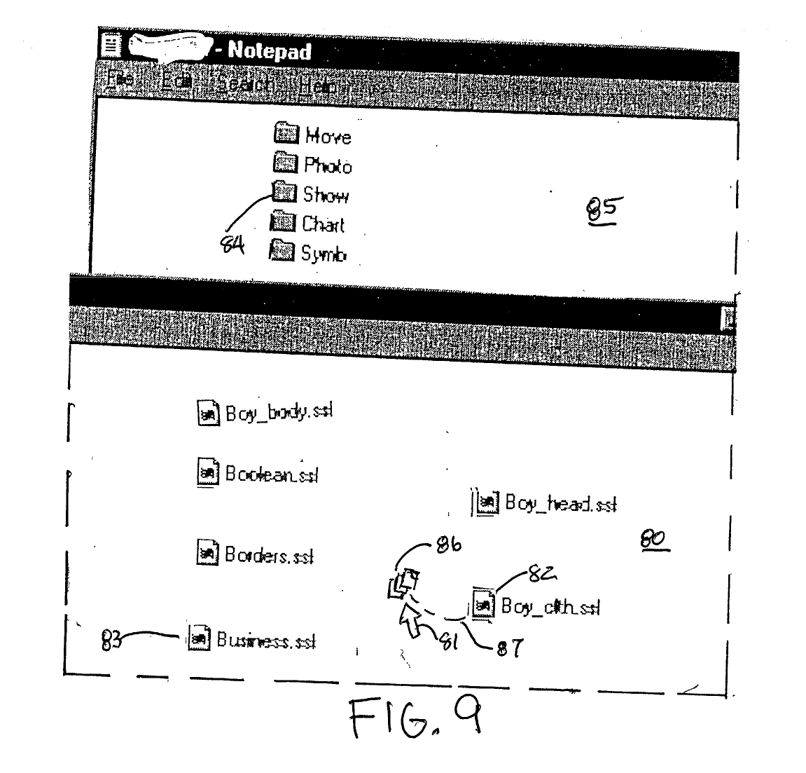

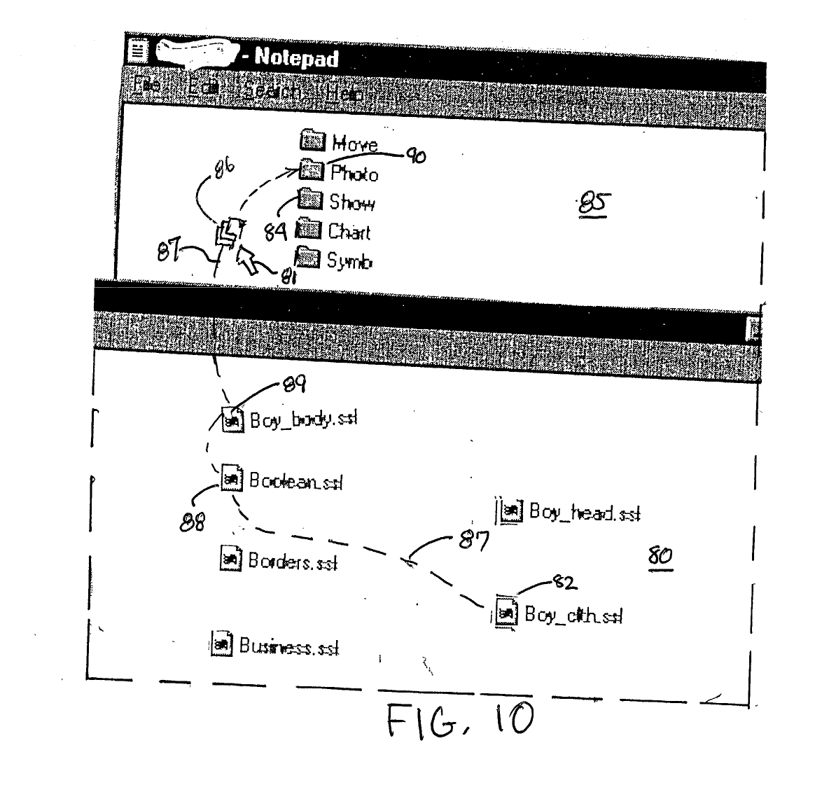

With reference to FIG. 8, there will be described a variation of the procedure of FIG. 1 wherein beginning with an initial file, a stack of files is created and an icon representative of the stack is moved to a destination folder. Here let us assume that icon 82 representing a file in a set of files 83 in window 80 is to be dragged from the source position shown and then dropped at a destination position to be subsequently described with respect to FIG. 10. The user moves mouse pointer 81 to the source position of file icon 82 and, by appropriate mouse pointer clicking, takes hold of file icon 82. The icon file may now be marked and represented by icon 86 that shows the image of a file stack. File stack icon 86 is then dragged along path 87 shown in FIG. 9. Then, with respect to FIG. 10, the subsequent path of the dragged file stack icon 86 and its various stops are shown as dashed lines. Along its path 87, the file stack icon 86 is dragged by the pointer 81 so that it traverses icon files 88 and then 89. At each of these stops, as indicated by the dashed lines, the contents of the dragged icon 86 is modified to include the contents of the files represented by icons 88 and 89 through appropriate mouse pointer clicking as dragged stacked file icon 86 traverses icons 88 and 89. During this traversal by file icon 86, the contents of the files represented by icons 88 and 89 are temporarily stored or cached. When the dragged stacked file icon 86 reaches its destination, which, in the present case is icon folder 90 in set 84, the contents represented by stacked file icon 86 have been significantly modified to include the contents of cached files represented by icons 88 and 89.

One of the implementations of the present invention is as an application program 40 made up of programming steps or instructions resident in RAM 14, FIG. 5, during computer operations. Until required by the computer system, the program instructions may be stored in another readable medium, e.g. in disk drive 20 or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Internet, when required by the user of the present invention. One skilled in the art should appreciate that the processes controlling the present invention are capable of being distributed in the form of computer readable media of a variety of forms.

While the invention has been shown and described with reference to particular embodiments thereof, it will be understood by those skilled in the art that the foregoing and other changes in form and detail may be made therein without departing from the spirit and scope of the invention.

What is claimed is:

1. In a computer controlled user interactive display system, a display screen interface implementation for enabling an interactive user to move a data component from a source to a destination in said system comprising:
means for representing said data component by an item on said display screen;
means for interactively dragging said item from an initial location on said screen representative of said source to a final location representative of said destination; and
means for interactively modifying said data component before said dragged item reaches said final location.

2. The computer controlled user interactive display system of claim 1 wherein said means for modifying said data component interactively manipulates said dragged item.

3. The computer controlled user interactive display system of claim 2 wherein said dragged item is an icon.

4. The computer controlled user interactive display system of claim 3 wherein said means for dragging said icon includes means for dragging said icon into contact with another icon to thereby activate said means for interactively modifying the data component represented by said dragged icon.

5. The computer controlled user interactive display system of claim 3 wherein said means for interactively modifying the data component represented by the dragged icon includes means moving said another icon into contact with the dragged icon.

6. The computer controlled user interactive display system of claim 4 wherein said means for modifying the data component modify the data content of the component.

7. The computer controlled user interactive display system of claim 6 wherein:
said another icon represents another data component; and
said data component is modified by combining data content from said another data component with the data content of said data component.

8. A method for enabling an interactive user to move a data component from a source to a destination through a display screen interface in a computer controlled user interactive display system comprising:
representing said data component by an item on said display screen;
interactively dragging said item from an initial location on said screen representative of said source to a final location representative of said destination; and
interactively modifying said data component before said dragged item reaches said final location.

9. The method of claim 8 wherein said step of modifying said data component interactively manipulates said dragged item.

10. The method of claim 9 wherein said dragged item is an icon.

11. The method of claim 10 wherein said step of dragging said icon includes the step of dragging said icon into contact with another icon to thereby activate said interactive modification of the data component represented by said dragged icon.

12. The method of claim 10 wherein said step of interactively modifying the data component represented by the dragged icon includes the step of moving said another icon into contact with the dragged icon.

13. The method of claim 11 wherein said step of modifying the data component modifies the data content of the component.

14. The method of claim 13 wherein:
said another icon represents another data component; and
said data component is modified by combining data content from said another data component with the data content of said data component.

15. A computer program having program code included on a computer readable medium for enabling an interactive user to move a data component from a source to a destination through a display screen in a computer controlled user interactive display system comprising:
means for representing said data component by an item on said display screen;
means for interactively dragging said item from an initial location on said screen representative of said source to a final location representative of said destination; and
means for interactively modifying said data component before said dragged item reaches said final location.

16. The computer program of claim 15 wherein said means for modifying said data component interactively manipulates said dragged item.

17. The computer program of claim 16 wherein said dragged item is an icon.

18. The computer program of claim 17 wherein said means for dragging said icon includes means for dragging said icon into contact with another icon to thereby activate said means for interactively modifying the data component represented by said dragged icon.

19. The computer program of claim 17 wherein said means for interactively modifying the data component represented by the dragged icon includes means for moving said another icon into contact with the dragged icon.

20. The computer program of claim 18 wherein said means for modifying the data component modify the data content of the component.

21. The computer program of claim 20 wherein:
said another icon represents another data component; and
said data component is modified by combining data content from said another data component with the data content of said data component.

22. In a computer controlled user interactive display system, a display screen interface implementation for enabling an interactive user to move a data component from a source to a destination in said system comprising:
a display screen icon representing said data component;
a mechanism for interactively dragging said icon from an initial location on said screen representative of said source to a final location representative of said destination; and
a mechanism for interactively modifying said data component before said dragged icon reaches said final location.

23. The display screen interface implementation of claim 22 wherein said mechanism for modifying said data component interactively manipulates said dragged icon.

24. The display screen interface implementation of claim 23 wherein said mechanism for dragging said icon includes an implement for dragging said icon into contact with another icon to thereby activate said mechanism for interactively modifying the data component represented by said dragged icon.

25. The display screen interface implementation of claim 23 wherein said mechanism for interactively modifying the data component represented by the dragged icon includes an implement for moving said another icon into contact with the dragged icon.

26. The display screen interface implementation of claim 23 wherein:
said mechanism for interactively dragging said icon utilizes a user manually controlled on-screen pointer; and
said mechanism for interactively modifying said data component also utilizes said user manually controlled on-screen pointer.
